(19) United States
(12) Patent Application Publication
(10) Pub. No.: US 2004/0070507 A1
(43) Pub. Date: Apr. 15, 2004

(54) Inventory management system

(76) Inventor: Richard John Campero, Ellicott City, MD (US)

Correspondence Address: Donald L. Bowman, MeadWestvaco Corporation, 11101 Johns Hopkins Road, Laurel, MD, 20723, US

(21) Appl. No.: 10/269,766

(22) Filed: Oct. 11, 2002

(51) Int. Cl. G08B 13/14

(52) U.S. Cl. 340/572.9

(57) ABSTRACT

The invention provides an improved inventory management and theft detection system whereby by a security tag is placed on an article for sale. The security tag is affixed to the article so that the article cannot be opened when the security tag is in place. A device to remove the security tag is controlled by the cash register of the store. The security tag removal device is controlled by the cash register and does not operate unless a sales transaction has occurred.

### CROSS-RELATED APPLICATIONS

This application claims priority from U. K. Patent Application No. 00275537, ('537 application) filed Nov. 10, 2000, and U.S. Provisional Application No. 60/328,193 filed Oct. 11, 2001, the entire disclosures of which are herein incorporated by reference.

### BACKGROUND OF THE INVENTION

This invention relates to an apparatus and system for securing and managing inventory, such as an article security tag and security tag release device, and point of sale terminal.

Various types of containers are known for holding products such as in a retail store. Numerous security and inventory management systems have been developed such as theft detection tags, physical objects to be removed by the sales clerk, and bar codes. One exemplary product to be managed is information storage media, such as compact discs (CD's) and digital video discs (DVD's). An exemplary state of the art container for storage media is described in U.S. Pat. No. 5,788,068 and WO97/41563, the disclosures of which are incorporated by reference herein.

An exemplary problem with prior art containers for storage media is the theft of the storage media, e.g. the CD or DVD, from the container inside the retail store. Conventionally, containers are provided with an Electronic Article Surveillance (EAS) tag that triggers an alarm if the container is taken out of the store without the EAS tag either being removed or rendered inactive by the store sales staff. One way to counter an EAS tag is simply to remove the storage media from the container. One method of countering this theft technique is to wrap the container in a clear plastic wrapper. The wrapper must be at least partially removed before the container can be opened. However, thieves have been known to slit the wrapper along an edge of the container and removed the storage media by manipulating the container. Moreover, thieves have developed additional techniques to include removing the EAS tag from the container or product.

U. K. Patent Application No. 00275537 ('537) describes an improved security tag that secures storage media inside the container. The security tag described in this application secures the storage media in the container and prevents the container from opening while the security tag is in place. However one potential problem with the '537 application is that an employee or thief with access to a security tag removal system can circumvent this feature.

What is needed is an improved inventory management and theft deterrent system whereby a security tag, such as described in the '537 application cannot be removed unless a sales transaction has occurred.

### SUMMARY OF THE INVENTION

The invention provides an improved inventory management system whereby by a security tag is placed on an article for sale. The security tag is affixed to the article so that a packaging cannot be opened with the security tag in place. A device to remove the security tag is controlled by the point of sale terminal. The tag removal device will not operate unless a sales transaction takes place.

### BRIEF DESCRIPTION OF THE FIGURE

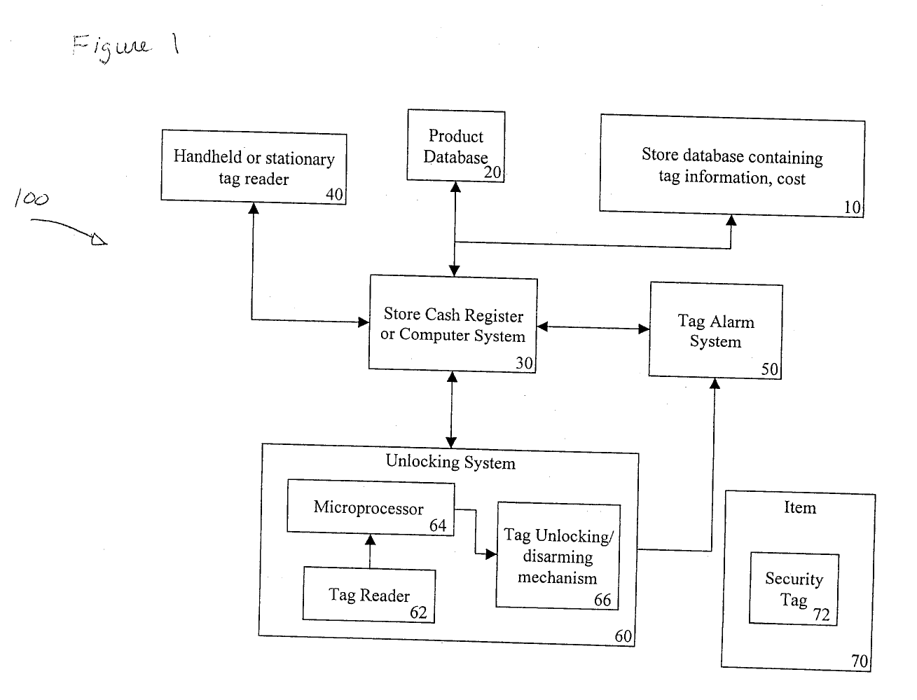

The above and other features of the present invention which will become more apparent in the description below and can be understood by the following detailed description in conjunction with the accompanying FIGURE. FIG. 1 is a schematic diagram of an inventory management system according to the invention.

### DETAILED DESCRIPTION OF THE INVENTION

FIG. 1 is a schematic diagram of an inventory management system 100. An exemplary inventory item 70 is shown. In an exemplary embodiment, item 70 is a storage media container (not shown) with an information storage media, such as a CD or DVD located inside the container. The storage media is secured inside the container by a security tag 72 such as described in the '537 application tat uses a RFID tags for preventing theft. In an exemplary embodiment, the security tag 72 has a Radio Frequency Identification Device (RFID) attached to it. It is to be understood that the invention covers a wide range of security tags 72 and is not limited to the security tag described in the referenced '537 application.

The inventory system 100 consists of at least a storage database 10, a cash register or sales terminal 30, an inventory item 70, a security tag 72 secured to the inventory item 70 or a container for the item 70, a security tag reader 40, and an unlocking system 60. FIG. 1, also shows an optional remote database 20 and an alarm system 50, such as an audible alarm located near the exits of a facility.

The inventory system 100 is designed so that security tag 72 is only released from an item 70 after a cash register 30 has recorded the sale of the item 70. In an exemplary system, the security tag 72 contains at least a serial number or some identification information that can be read by an optical or other type of scanner. Additional information could be stored on the tag, such as item type, item identification number, tag number, item description, item cost, date of manufacture, shipping date and reorder information. A serial number allows each item 70 and security tag 72 to be uniquely identified by the cash register or computer system 30. The security tag 72 is exemplary placed in the item 70 at the factory or by the retailer, distributor, or owner, preferably prior to arrival at the store or in a secure location. An optional remote database 20 could be used to cross-reference the information stored on the tag 72.

In an exemplary embodiment, during a sales transaction, the cash register 30 or other suitable reading device will read the security tag 72 identification information. In an exemplary system a handheld or stationary security tag reader 40, such as an electronic or optical scanner is used to read the security tag 72. The tag reader 40 transfers the information to the cash register 30. The cash register 30 then communicates with a storage database 10. The storage base 10 transmits to the cash register 30 information on the item 70, such as product cost and other information desired. In addition, a remote product database 20 may be desirable to prevent an employee or thieve from altering the store database 10.

After the security tag 72 information is read by the tag reader 40, the cash register 30 will authorize the removal of or disarming of the security tag 72. A sales clerk can then use an exemplary tag unlocking system 60 to remove the security tag 72 from the item 70. The tag unlocking system 60 is controlled by the cash register 30. In an exemplary embodiment the tag unlocking system 60 comprises a security tag reader 62, a microprocessor 64, and an unlocking device 66.

The unlocking system tag reader 62 reads the security tag 72. The tag's identification number is transferred via a microprocessor 64 to the cash register 30 to confirm or verify the sale. If a sale is confirmed, the unlocking device 66 is made operational and the sales clerk can proceed with disarming and removing the security tag 72. If a sale is not confirmed then the unlocking device 66 will not operate. In an exemplary embodiment, an attempt to unlock a security tag 72 when a sale is not recorded would result in an exemplary alarm system 50 activating.

Thus employees as well as thieves could not remove the security tag 72 from the item 70 without a sales transaction. It is to be understood that the unlocking device 66 can be configured and controlled in many different ways, including electromagnetic controls or other suitable electromechanical means.

As previously mentioned, the system 100 could also have an alarm system 50. An exemplary alarm system 50 would be placed near the store exit or tag unlocking device 661. The alarm 50 would make a noise or flash a light if a thief or employee attempts to remove the item 70 from the store without a sales transaction occurring.

One potential problem is that an employee could authorize a cash transaction with the cash register 30, without placing the money in the cash register. However, a password system can also be used with the cash register 30 to identify which sales clerk handled a particular transaction.

Once given the above disclosure, many other features, modifications or improvements will become apparent to the skilled artisan. Such features, modifications or improvements are, therefore, considered to be a part of this invention, the scope of which is to be determined by the following claims.

1. An inventory management system comprising:
an inventory item;
a releasable security tag; wherein said releasable security tag is secured to said inventory item;
an inventory database;
a point of sale terminal;
a security tag reader;
a unlocking device for releasing said security tag wherein said unlocking device is controlled by said point of sale terminal; and
a security tag alarm system, wherein said alarm system detects the unauthorized removal of the security tag from the inventory item.

2. The inventory management system of claim 1 wherein said security alarm system detects the unauthorized removal of the security tag across a designated store boundary.

3. The inventory management system of claim 1 wherein said security tag comprises an apparatus inserted into a container and requiring a special apparatus to remove said security tag.

4. The inventory management system of claim 1 wherein said inventory item is an information storage media article secured to a container.

5. The inventory management system of claim 4 wherein said security tag retains said information storage media item in said container.

6. The inventory management system of claim 1 wherein said point of sale terminal is in communication with said inventory database, said security tag reader, said unlocking device, and said alarm system.
